(19) United States
(12) Patent Application Publication
(10) Pub. No.: US 2012/0142224 A1
(43) Pub. Date: Jun. 7, 2012

(54) M.C. Cord adapter

(76) Inventor: Rennard Raymond McCord, Tampa, FL (US)

(21) Appl. No.: 12/803,957

(22) Filed: Dec. 7, 2010

(51) Int. Cl. H01R 24/60

(52) U.S. Cl. 439/668

(57) ABSTRACT

A consumer assembled electric power cord adapter which has an squared insulator body defining a enclosure and a identical pair of alloyed metal electric conductors which fit securely attached on the inside of the enclosure. A low flow of positive and negative electric current is directed to the identical alloyed conductors when the consumer strips the wire of a barbers' clipper cord and self assembles those wires through the designer orifice of the identical alloyed conductors then securely attach them within the inside of the enclosures. An electric path is formed immediately after the enclosures are properly sealed with two screws and bolts, and a standard adapter wire is attached onto the protruding alloyed conductors and a energized wall receptacle.

FIG. 1 is a top plan view of one of two identical metal alloyed electric conductors for hand held barber's clippers comprising the first embodiment of the present invention;

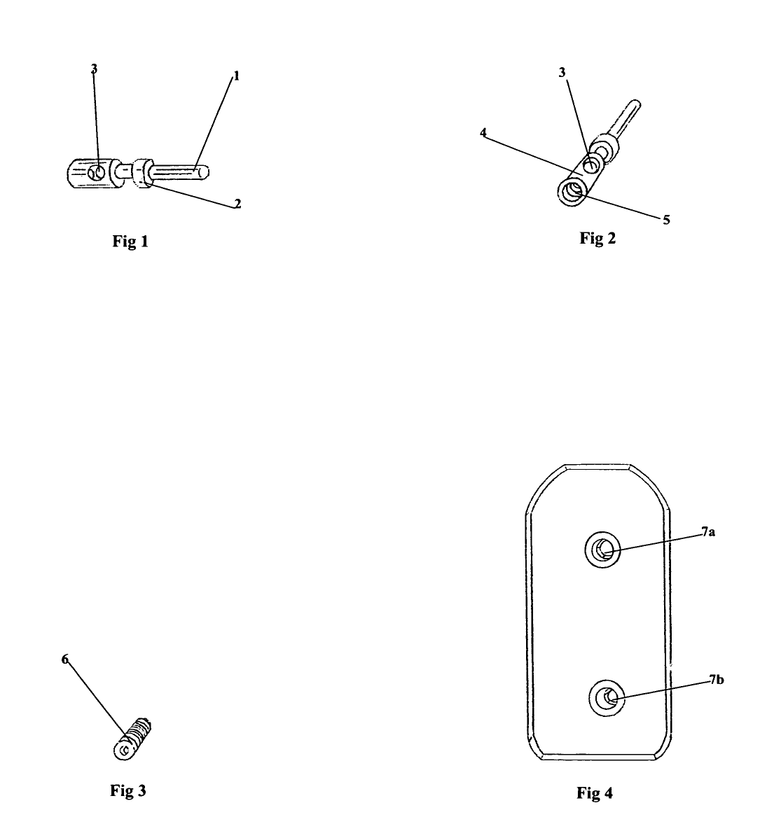

FIG. 2 is a top plan diagonal view of one of the two identical metal alloyed electric conductors for hand held barber's clippers comprising the first embodiment of the present invention;

FIG. 3 is a top plan diagonal view of one of two identical metal wire support screws which screw into the rear of the two identical metal alloyed electric conductors used for tightened securely against a stripped barber's clipper wire enabling direct electric current flow;

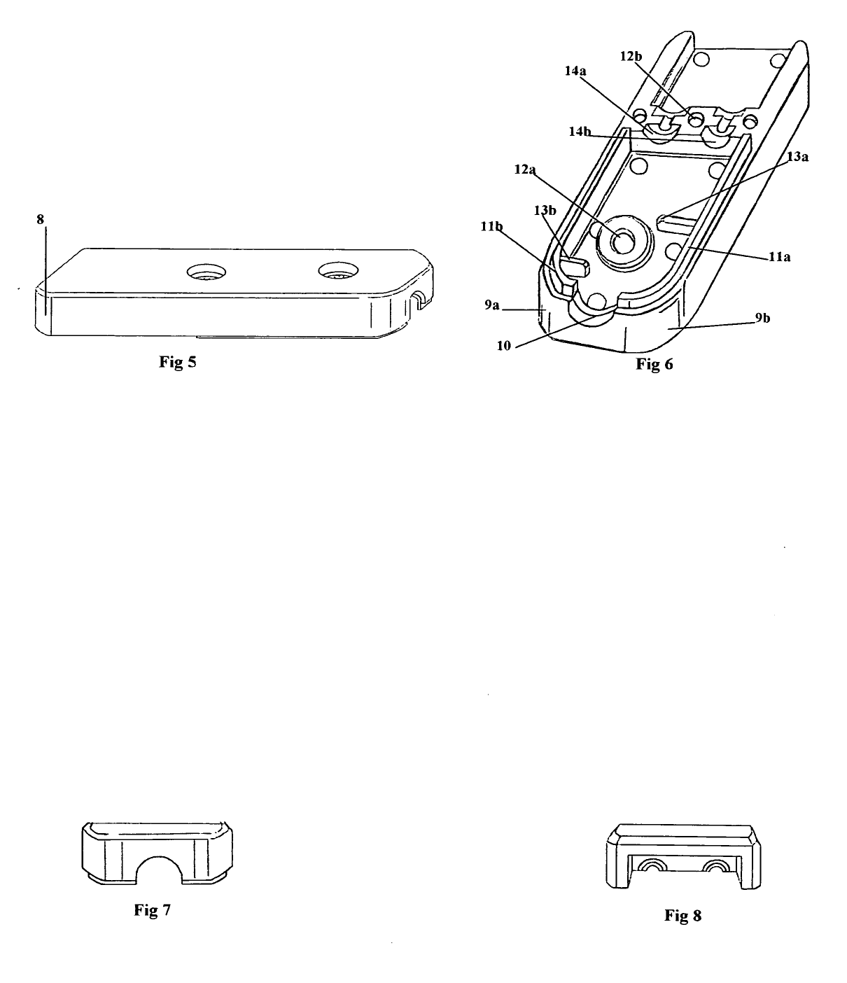

FIG. 4 is a top plan view of one of a two part plastic insulators with male and female attachment designs which houses the two identical metal alloyed electric conductors while adding resistance to the electric current of the present invention;

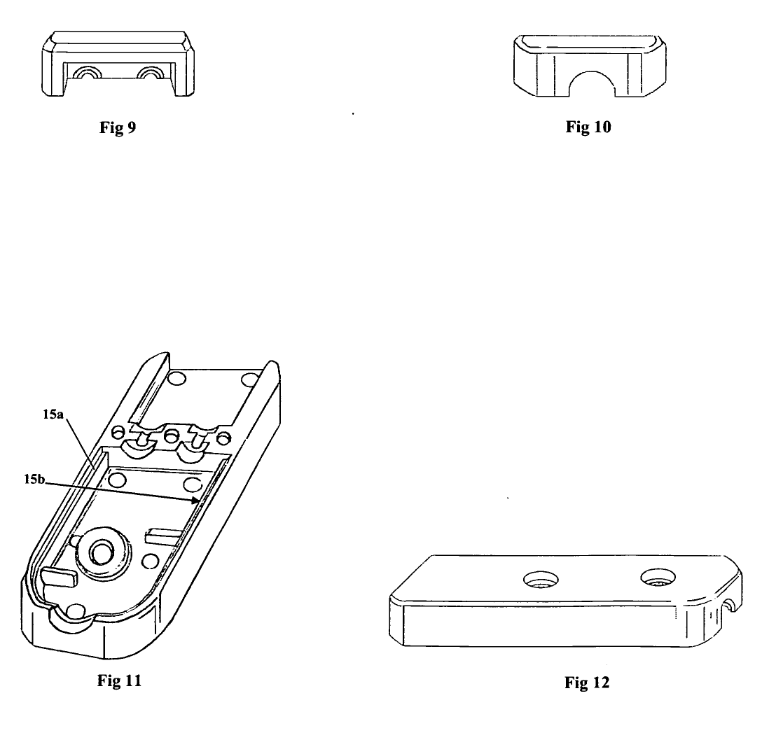

FIG. 5 is a side view of the male part of the plastic insulator which houses the two identical metal alloyed electric conductors while adding resistance to the electric current of the present invention;

FIG. 6 is a top diagonal inside reverse view of the male part of the plastic insulator which houses the two identical metal alloyed electric conductors while adding resistance to the electric current of the present invention;

FIG. 7 is a front view of the male part of the plastic insulator which houses the two identical metal alloyed electric conductors while adding resistance to the electric current of the present invention;

FIG. 8 is a back view of the male part of the plastic insulator which houses the two identical metal alloyed electric conductors while adding resistance to the electric current of the present invention;

FIG. 9 is a back view of the female part of the plastic insulator which houses the two identical metal alloyed electric conductors while adding resistance to the electric current of the present invention;

FIG. 10 is a front view of the female part of the plastic insulator which houses the two identical metal alloyed electric conductors while adding resistance to the electric current of the present invention;

FIG. 11 is a top diagonal inside reverse view of the female part of the plastic insulator which houses the two identical metal alloyed electric conductors while adding resistance to the electric current of the present invention;

FIG. 12 is a side view of the female part of the plastic insulator which houses the two identical metal alloyed electric conductors while adding resistance to the electric current of the present invention;

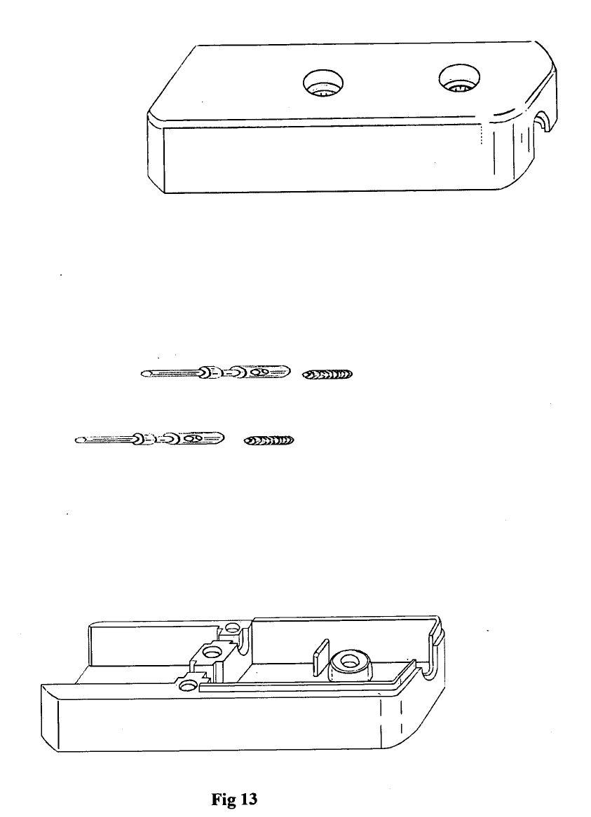

FIG. 13 is a exploded view of all six parts of the preferred embodiment of the present invention for the M.C. Cord Adapter device for barber clippers;

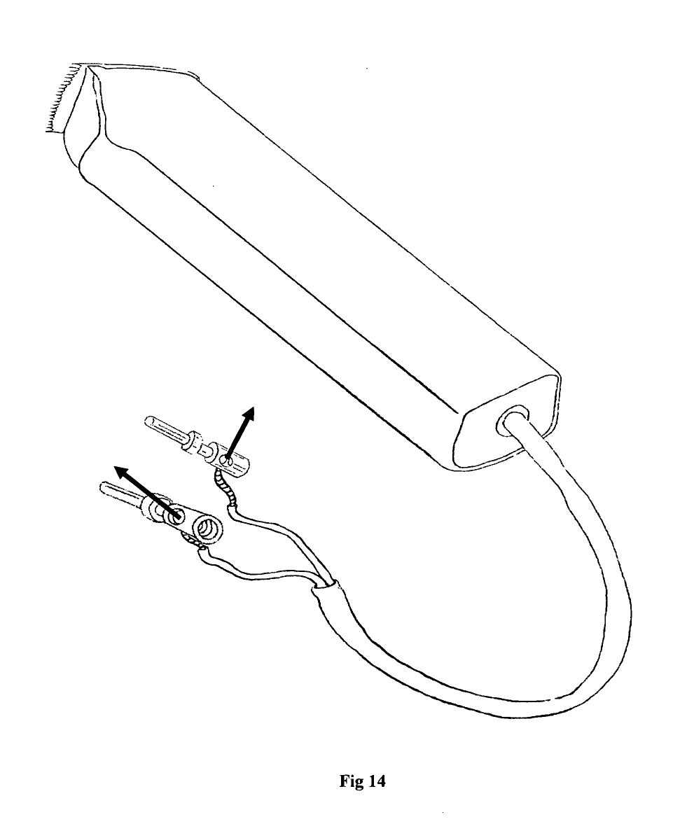

FIG. 14 is a front side view of how the two identical metal alloyed electric conductors will be self assembled onto the negative and positive wire of preferred embodiment of the present invention for the M.C. Cord Adapter device utilized for barber clippers;

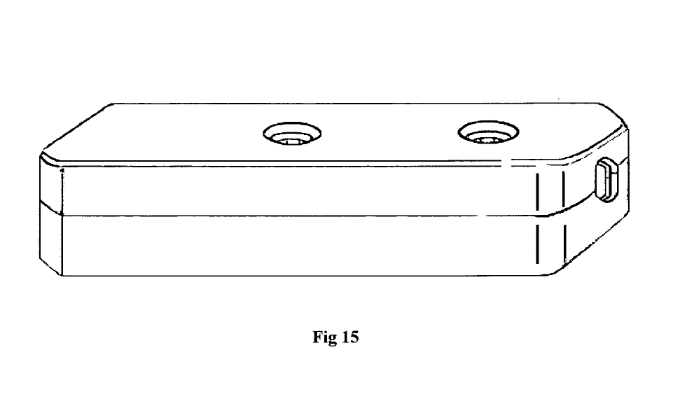

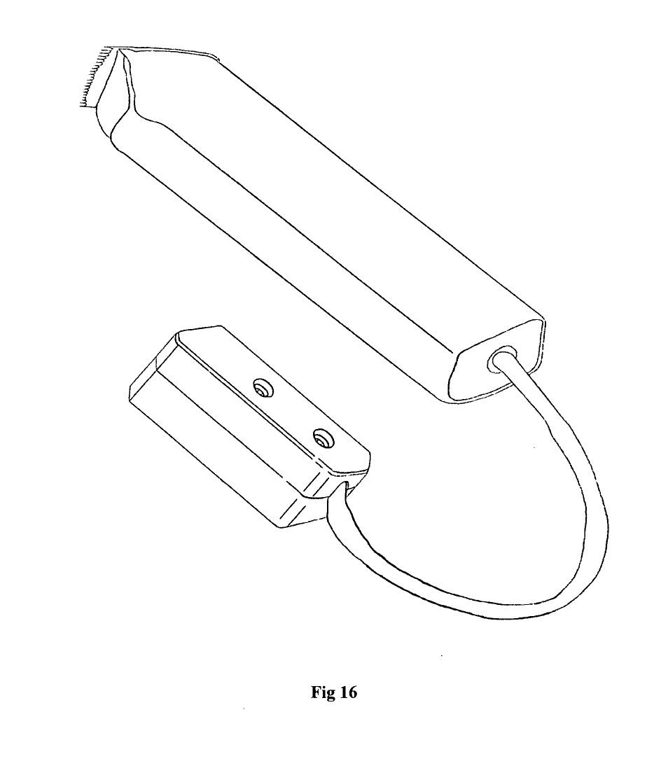

FIG. 15 is a side diagonal view of the intact preferred embodiment of the present invention for the M.C. Cord Adapter device part of the utility adapter for barber clippers;

FIG. 16 is a front side view of how the intact preferred embodiment of the present invention for the M.C. Cord Adapter device will appear on standard barber clippers;

### BRIEF DESCRIPTION OF SEVERAL VIEWS OF THE DRAWINGS AS REQUIRED BY 37CFR 1.74 AND 37CFR 1.77(b)(7)

Referring now to the drawings, and particularly to FIGS. 1-3, shown therein is a top plan view of one of two identical metal alloyed conductor's male shaft 1 designed to be inserted into a two prone electric cord adapter. This male shaft is designed with a custom support bar 2 and a female shaft 4 which enables the conductors to be securely held and locked into custom designed import chambers 14a and 14b. The female shaft 4 also has a drilled hole through it's exterior apparatus 3 which allows for a stripped end of a barber's cord wire to be manually inserted for direct electric current to flow. There is a bored screw hole 5 at the rear of the female shaft which serves simultaneous purposes. The purposes are one, to allow for a custom metal support screw 6 to be inserted and two, then this screw is tightened securely against the stripped barber's clipper wire creating direct contact needed for electric current flow.

Turning now to the drawings at FIGS. 4-6. FIG. 4 is a top plan view of the male part of the two part plastic electric insulator shells showing two custom drilled holes 7a and 7b for allowance of two identical screws and their attachment bolts which are used to securely lock the male and female plastic insulators together during product assembling. FIG. 5 is a side view of the male part of the plastic insulator showing a custom curved designer rear 8 which aids in eliminating garment snags or tears. At FIG. 6 the front of the male plastic insulator is also custom curved 9a and 9b to aids in eliminating garment snags and tears. A ¼ diameter port 10 allows an exit for the attached stripped barber's clipper cord when it is attached to the alloyed conductors.

Also shown at FIG. 6 are a set of raised male fitting apparatus 11a and 11b, which fits securely and locks on top of the female apparatus 15a and 15b. Although this inventor has shown and described the electric insulator shells showing its two custom drilled holes 7a and 7b for allowance of two identical screws and their attachment bolts, at 12a, 12b,14a and 14b are their reverse sides which serves the multi purposes of completing the structural make up of the designer import chambers 12b,14a and 14b and giving the device more structural fortitude at 12a. An additional two custom support brackets 13a and 13b are designed within the device walls to strengthen from ease of cracks if dropped onto a hard surface.

This device comprises male and a female plastic insulator shells which house and support the two metal alloyed electric conductors. The insulator shells are identical in size and shape with the exception of one primary feature, the custom designed grooved or sunken female fitting apparatus 15a and 15b, which enables the male fittings 11a and 11b to fit securely on to its female apparatus. Please see the top diagonal inside reverse view of the female part of plastic insulator at FIG. 11.

I claim:

1. An electrical utility adapter suitable to be assembled to the end of an electric cord of Barbers' clippers by the consumer themselves, said utility adapter comprising of two plastic electric insulators which are designed with male and female connecting ends, said two plastic insulators are custom designed on each of their reverse sides to house immovably when connected the two identically designed metal alloyed electrical conductors, said two identically designed metal alloyed electrical conductors consisting of two purpose ends, first of said ends are designed to mate with a traditional electric cord adapter's end which is to be placed in a basic electric socket, second of said end bears two holes in it's composition, first of said two holes is drilled through the body of the metal alloyed conductor which is used as an insert port for one of two striped wire ends which are connected to the cord end of barbers clippers, second of said two holes is a screw fitting hole which one of two identical metal wire support screws are inserted to work as a vice support to one of the two striped wire ends which are connected to the cord end of barbers clippers part of my electric utility adapter, as shown and described.
